(19) United States
(12) Patent Application Publication
(10) Pub. No.: US 2026/0338978 A1
(43) Pub. Date: Oct. 29, 2026

(54) METHOD, SYSTEM, AND COMPUTER DEVICE FOR FIRST-ARRIVAL PICKING OF SEISMIC DATA

(71) Applicant: NORTHEAST PETROLEUM UNIVERSITY, Daqing (CN)

(72) Inventors: Hongli DONG, Daqing (CN); Hanyang LI, Daqing (CN); Yuhang SUN, Daqing (CN); Jiahui LI, Daqing (CN); Xuegui LI, Daqing (CN); Yan ZHANG, Daqing (CN)

(73) Assignee: NORTHEAST PETROLEUM UNIVERSITY, Daqing (CN)

(21) Appl. No.: 19/703,468

(22) Filed: Jun. 10, 2026

Related U.S. Application Data
(63) Continuation of application No. PCT/CN2024/141667, filed on Dec. 24, 2024.

(30) Foreign Application Priority Data
Jan. 26, 2024 (CN) 202410108831.4

(51) Int. Cl. G01V 1/28; G06N 3/092

(52) U.S. Cl. CPC G01V 1/282; G06N 3/092

(57) ABSTRACT

A method for first-arrival picking of seismic data includes: acquiring seismic data; using an automatic first-arrival picking algorithm to perform preliminary picking of first-arrival times of seismic signals in the seismic data, and generating a training set; performing manual correction on the first-arrival times picked by the automatic first-arrival picking algorithm, and generating a validation set; using the training set and the validation set to respectively create noisy labels and clean labels, and generating a meta-learning dataset; designing a corresponding deep neural network model based on characteristics of the meta-learning dataset; performing iterative training on the deep neural network model by using the meta-learning dataset based on an inner and outer double-loop training procedure of meta-learning; and using the trained deep neural network model to perform first-arrival picking on seismic data.

### CROSS-REFERENCE TO RELATED APPLICATIONS

This application is a continuation of International Application No. PCT/CN2024/141667, filed on Dec. 24, 2024, which claims priority to Chinese Patent Application No. 202410108831.4, filed on Jan. 26, 2024. All of the aforementioned applications are incorporated herein by reference in their entireties.

### TECHNICAL FIELD

The present disclosure relates to the technical fields of seismic data processing and seismic monitoring, and specifically relates to a method, system, and computer device for first-arrival picking of seismic data.

### BACKGROUND

In the fields of seismic data processing and seismic monitoring, accurate first-arrival picking is of great significance.

Traditionally, the task of first-arrival picking is completed manually. However, with the explosive growth of data volume, manual operations can no longer meet the actual demands of seismic data processing. Therefore, data-driven automatic first-arrival picking methods have emerged.

However, data-driven first-arrival picking methods have a high dependency on a large amount of manually labeled data, requiring significant human and material resources. In addition, errors between the labeled first-arrival times and the actual first-arrival times caused by improper operation during the labeling process can lead to a label noise problem, affecting method performance. Meanwhile, data-driven first-arrival picking methods have a generalization problem when facing different noise characteristics and geological environments.

### SUMMARY

To address the generalization problem of existing data-driven first-arrival picking techniques when facing different noise characteristics and geological environments, the present disclosure proposes a method, system, and computer device for first-arrival picking of seismic data. The method performs iterative training on a deep neural network model by using a meta-learning dataset based on an inner and outer double-loop training procedure of meta-learning, and uses the trained deep neural network model to perform first-arrival picking on seismic data, thereby solving the generalization problem of existing data-driven picking techniques.

A method for first-arrival picking of seismic data includes the following steps: acquiring seismic data; using an automatic first-arrival picking algorithm to perform preliminary picking of first-arrival times of seismic signals in the seismic data, and generating a meta-learning dataset, wherein the meta-learning dataset comprises a training sample set and a validation sample set; designing a corresponding deep neural network model according to features of the meta-learning dataset; performing iterative training on a deep neural network model by using the meta-learning dataset based on an inner and outer double-loop training procedure of meta-learning; using the trained deep neural network model to perform first-arrival picking on to-be-detected seismic data; wherein, the inner and outer double-loop training procedure of meta-learning, which uses the meta-learning dataset to iteratively train the deep neural network model, each iteration of training comprises the following steps: sampling N mini-batch samples from the training sample set; assigning meta-network weights \hat{θ} to an independent sub-network; sampling M mini-batch samples from the validation sample set; using online gradient update, computing loss value of the sub-network, and backpropagating to optimize a weight matrix w; using the N mini-batch training samples and a processed weight matrix ω* resulting from processing the optimized weight matrix ω, calculating a gradient by using a loss function, and backpropagating to optimize the meta-network weights \hat{θ}.

In one embodiment, wherein after acquiring the seismic data, the seismic data is subjected to filtering, and then the filtered seismic data is subjected to cropping, normalization, and first-arrival picking operations.

In one embodiment, input data of the deep neural network model is a seismic record, each seismic record comprises 64 seismic traces, each seismic trace comprises 512 sampling points, and an interval between the sampling points is 10 milliseconds; and an output of the deep neural network model is a 0-1 matrix.

In one embodiment, the deep neural network model is a U-Net model.

In one embodiment, the using an automatic first-arrival picking algorithm to perform preliminary picking of first-arrival times of seismic signals in the seismic data to generate a meta-learning dataset specifically comprises: classifying sampling points before and after the picked first-arrival time into two categories of pre-first-arrival and post-first-arrival, and respectively assigning different labels thereto; using a first-arrival picking result with errors from the automatic first-arrival picking algorithm as a noisy label; using a first-arrival time subjected to manual correction as a clean label; and generating the meta-learning dataset based on the noisy labels and the clean labels.

In one embodiment, a loss function used is expressed as:

Loss=ωfᵢ(θ)
wherein ω is a weight matrix, fᵢ(θ) represents a loss function associated with a noisy label i, and θ represents trainable parameters of the deep neural network model.

In one embodiment, the using the N mini-batch training samples and the processed weight matrix ω* resulting from processing the optimized weight matrix ω, calculating a gradient by using the loss function, and backpropagating to optimize the meta-network weights \hat{θ} is specifically expressed as:

$$\{ \begin{matrix}θ * ( ω ) = arg min {\sum }_{i = 1}^{N} {ω f}_{i} ( θ ) \\ ω *= arg min {\sum }_{j = 1}^{M} {f}_{j} ( θ ( ω ) )\end{matrix}$$

wherein the symbol * denotes an optimal value of a parameter, and fᵢ represents a loss function associated with a clean label j.

In one embodiment, the using online gradient update, computing a sub-network loss, and backpropagating to optimize the weight matrix ω comprises: expressing an estimated value of the weight matrix ω as:

$$\hat{ω} ( T ) = - η \frac{\partial }{\partial ω} \frac{1}{m} {\sum }_{j = 1}^{m} {f}_{j} ( {θ}_{t + 1} ( ω ) {\vert}_{ω ← 0} )$$

wherein η is a learning rate of ω, t represents a current iteration number, and m is a number of samples in the M mini-batch samples;
performing normalization processing on the estimated value \hat{ω}(t), which is expressed as:

\hat{ω}(t)=max(0,\hat{ω}(t))

$$\hat{ω} ( T ) = \frac{\hat{ω} ( t )}{\sum \hat{ω} ( t ) + δ}$$

wherein δ is a minimal value for preventing ω from being all zero.

In one embodiment, a system for first-arrival picking of seismic data includes: an acquisition device configured to acquire seismic data; a dataset generation device configured to use an automatic first-arrival picking algorithm to perform preliminary picking of first-arrival times of seismic signals in the seismic data, and generate a meta-learning dataset, wherein the meta-learning dataset comprises a training set and a validation set; a training device configured to perform iterative training on a deep neural network model by using the meta-learning dataset based on an inner and outer double-loop training procedure of meta-learning; wherein each iterative training comprises: sampling N mini-batch samples from the training set; assigning meta-network weights \hat{θ} to an independent sub-network; sampling M mini-batch samples from the validation set; using online gradient update, computing a sub-network loss, and backpropagating to optimize a weight matrix ω; using the N mini-batch training samples and a processed weight matrix ω* resulting from processing the optimized weight matrix ω, calculating a gradient by using a loss function, and backpropagating to optimize the meta-network weights \hat{θ}; and a first-arrival picking device configured to input to-be-detected seismic data into the trained deep neural network model, and output a first-arrival picking result of the to-be-detected seismic data.

In one embodiment, a computer device for first-arrival picking of seismic data includes: a memory, a processor, and a computer program stored in the memory, wherein the processor, when executing the computer program, implements the steps of the method for first-arrival picking of seismic data described above.

The present disclosure provides a method, system, and computer device for first-arrival picking of seismic data, which have the following beneficial effects: The present disclosure uses an automatic first-arrival picking algorithm to pick first-arrival times of seismic signals in seismic data, thereby generating a meta-learning dataset; uses an inner and outer double-loop training procedure based on meta-learning to train a deep neural network model; and uses the trained deep neural network model to perform first-arrival picking on seismic data. This significantly reduces the human labor and resources required by data-driven first-arrival picking methods, lowers costs, and improves efficiency and accuracy. In addition, through the inner and outer double-loop training procedure and online gradient update, the present disclosure successfully solves problems such as noisy labels and training costs. Compared with existing methods, the present method can seamlessly adapt to various deep learning models, meets various end-to-end requirements, has higher efficiency than model-driven first-arrival picking methods, simultaneously solves the generalization problem of existing data-driven first-arrival picking techniques, and improves the picking accuracy and cost-effectiveness of data-driven methods.

### BRIEF DESCRIPTION OF THE DRAWINGS

FIG. 1 is a schematic diagram of a meta-learning structure in an embodiment of the present disclosure.

FIG. 2 is a schematic diagram of the structure of a U-Net model in an embodiment of the present disclosure.

FIG. 3 is a display diagram of data labels in an embodiment of the present disclosure.

FIG. 4 is a flowchart of an inner and outer double-loop training procedure based on meta-learning in an embodiment of the present disclosure.

FIG. 5 is a schematic diagram of field data picking using a trained U-Net model in an embodiment of the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure. Obviously, the described embodiments are only a part of the embodiments of the present disclosure, rather than all of the embodiments.

An automatic first-arrival picking method based on meta-learning includes the following steps: acquiring seismic data;
using an automatic first-arrival picking algorithm to perform preliminary picking of first-arrival times of seismic signals in the seismic data, and generating a training set;
performing manual correction on the first-arrival times picked by the automatic first-arrival picking algorithm, and generating a validation set;
using the training set and the validation set to respectively create noisy labels and clean labels, and generating a meta-learning dataset;
designing a corresponding deep neural network model based on characteristics of the meta-learning dataset;
performing iterative training on the deep neural network model by using the meta-learning dataset based on an inner and outer double-loop training procedure of meta-learning; and
using the trained deep neural network model to perform first-arrival picking on seismic data;
wherein the performing iterative training on the deep neural network model by using the meta-learning dataset based on the inner and outer double-loop training procedure of meta-learning, each iterative training includes the following steps:
sampling N mini-batch samples from the training set; setting an initial weight matrix ω₀, calculating a gradient according to a loss function, and backpropagating to optimize meta-network weights \hat{θ}; assigning meta-network weights \hat{θ} to an independent sub-network; sampling M mini-batch samples from the validation set; using online gradient update, computing a sub-network loss, and backpropagating to optimize a weight matrix ω; processing the optimized weight matrix ω to maintain training stability; using the N mini-batch training samples and a processed weight matrix ω* resulting from processing the optimized weight matrix ω, calculating a gradient by using a loss function, and backpropagating to optimize the meta-network weights \hat{θ}.

As a class of methods in deep learning, meta-learning can enable a model to quickly adapt to new tasks under conditions of limited data and iterations. The present disclosure uses the meta-learning concept, a schematic diagram of which is shown in FIG. 1. A model is trained through a series of different tasks, so that the model learns the “ability to learn,” i.e., the “meta-learning knowledge” in FIG. 1. This knowledge endows the model with stronger adaptability, enabling the model to effectively and quickly handle new tasks that have not been seen before. The method specifically includes the following steps.

Step 1: First, seismic data from a mining area in a certain region of China is acquired, and then preliminary filtering is performed on the acquired seismic data to remove noise, thereby improving the signal-to-noise ratio and quality of the field seismic data. Subsequently, the filtered seismic data is subjected to operations such as cropping, normalization, and first-arrival picking. Non-picking seismic traces are deleted, and data with no valid time is truncated to create a dataset conforming to an input paradigm of a deep neural network model: each sample in the dataset includes 64 traces, each trace includes 512 sampling points, and the interval between each sampling point is 1 millisecond.

Step 2: The present disclosure does not involve improvements to the model itself. The choice of the deep neural network depends on the complexity of the data and the specific requirements of the application. The Convolutional Neural Network (CNN) model and the U-Net model are two models widely used in first-arrival picking tasks. Considering that the first-arrival picking task needs to capture pixel-level details and preserve spatial context information, the U-Net model is used as an exemplary model for implementing the present disclosure.

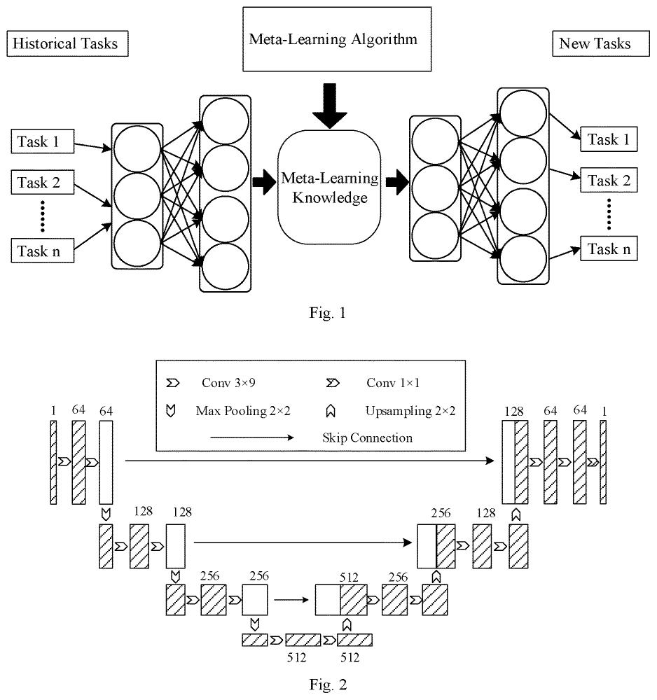

The specific number of layers and structure of the U-Net model are designed based on data and experience. A schematic diagram of the U-Net model is shown in FIG. 2. The U-Net model includes convolution operations, pooling operations, deconvolution operations, and skip connections. The exemplary U-Net model used is composed of six blocks, including three contracting path blocks and three expansive path blocks. Each contracting path block includes three convolutional layers and one max pooling layer. When a feature map passes through each block, the number of channels doubles while the size is halved. Conversely, each block in the expansive path doubles the size of the input feature map and reduces the number of channels by half through deconvolution. Then, the modified feature map is fused with the feature map saved in the corresponding contracting path through a skip connection.

Step 3 and Step 4: The STA/LTA algorithm and manual operation are used to perform preliminary first-arrival picking and correction on seismic events.

First, an automatic first-arrival picking algorithm (i.e., the STA/LTA algorithm) is used to perform preliminary picking of first-arrival times of seismic signals in the data. Due to the variability of seismic signals and the complexity of subsurface media, this automatic first-arrival picking algorithm has accuracy problems. Therefore, manual correction is subsequently performed on a small portion of the first-arrival times picked by the STA/LTA algorithm (in the exemplary training, the corrected samples account for 5% of the total number of samples).

Step 5: Labels are created to generate a meta-learning dataset.

As a pixel-wise segmentation task, the common practice for the first-arrival picking task is to assign a binary value (0 or 1) to each pixel in the sample. There are two different methods to implement this. The first method is to classify the picked first-arrival time or several sampling points near the first-arrival time into one category, and classify the remaining pixels into another category. Because the above label-making method has the problem of sample imbalance, methods such as cost-sensitive learning functions are needed to solve this problem. Therefore, another label-making method is adopted, namely, classifying the sampling points before and after the picked first-arrival time into two categories, and respectively assigning different labels (0 or 1) thereto.

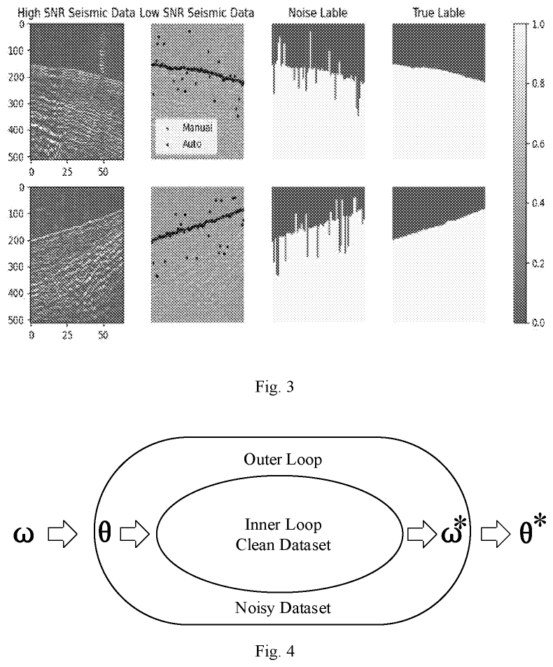

Specifically, the potentially erroneous first-arrival times picked by the STA/LTA algorithm are used as noisy labels, while clean labels are created based on manually corrected (e.g., expert-corrected) first-arrival times. FIG. 3 shows the seismic data and the corresponding clean labels and noisy labels created, clearly comparing the seismic data and the differences between the clean labels with manual correction and the noisy labels without manual correction. The manually corrected dataset is used as a validation set. The remaining uncorrected data, i.e., the first-arrival times automatically picked by the STA/LTA algorithm, is used as a training set. When training the model, both the validation set and the training set participate in the training.

Step 6: An inner and outer double-loop training procedure based on meta-learning.

To solve the error problem of the STA/LTA algorithm in first-arrival picking, during the training phase, the validation dataset with clean labels is used to guide the deep neural network, so as to encourage the network to perform adaptive learning from the training dataset samples with label noise, thereby enabling the network to effectively assign appropriate weights to the gradient of each sample. Specifically, a weighted loss function is designed:

Loss=wfᵢ(θ) (1)

In formula (1), ω is a weight matrix, used to eliminate loss errors caused by model prediction inaccuracies and inaccurate labels due to label noise during the training process. Operationally, the weight matrix ω will be adaptively adjusted during the training process, assigning lower weights to noisy labels and higher weights to noise-free labels. fᵢ(θ) represents a loss function associated with a noisy label i, wherein θ represents trainable parameters of the model.

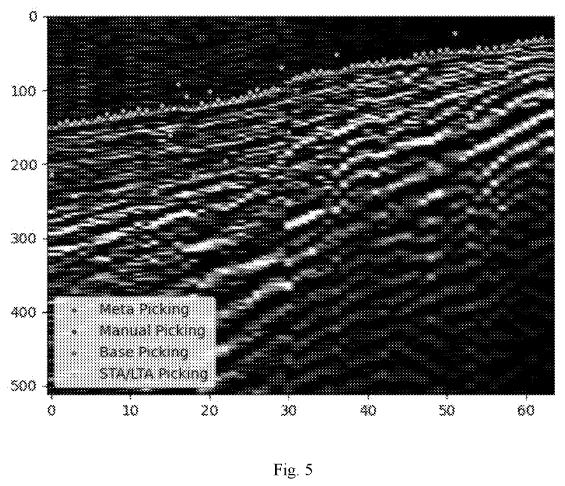

The training of the model in the present disclosure adopts the inner and outer double-loop training procedure based on meta-learning. A training schematic diagram of the inner and outer double-loop is shown in FIG. 4. Specifically, during training, samples from the noisy dataset are used to update model parameters θ, and the validation set with clean labels is used to update the weight matrix ω:

$$\{ \begin{matrix}θ * ( ω ) = arg min {\sum }_{i = 1}^{N} {ω f}_{i} ( θ ) \\ ω *= arg min {\sum }_{j = 1}^{N} {f}_{j} ( θ ( ω ) )\end{matrix} \qquad ( 2 )$$

In formula (2), M and N respectively represent a number of samples in the training set and the validation set. In one iterative training, the update of the model parameters θ depends on the gradient computed from a mini-batch of samples in the training set. Taking the SGD optimization algorithm as an example:

$$\text{?} ( ω ) = {θ}_{t} - α ∇ {\sum }_{i = 1}^{n} {ω}_{0} {f}_{i} ( θ ( ω ) ) {\vert}_{θ = {θ}_{t}} \qquad ( 3 )$$

In formula (3), α is the learning rate. For the calculation of the gradient of the parameter ω, the present disclosure adopts online gradient update to reduce the computational burden brought by the inner and outer double-loop iterative training, using the gradient value of a mini-batch of samples in the validation set as the estimated value ω_{f}:

$$\hat{ω} ( t ) = - η \frac{\partial }{\partial ω} \frac{1}{m} {\sum }_{j = 1}^{m} {f}_{j} ( {θ}_{t + 1} ( ω ) {\vert}_{ω ← 0} ) \qquad ( 4 )$$

In formula (4), η is the learning rate of the parameter ω.

During the continuous training process, the model learns to assign larger weights to the losses provided by samples in the training set and the test set whose gradient directions are similar, and assign smaller weights to the losses provided by samples whose gradient directions are different. Subsequently, the estimated value ω(t) is processed to ensure it is a positive number, and normalization processing is performed to eliminate the influence of the learning rate η:

\hat{ω}(t)=max(0,\hat{ω}(t)) (5)

$$\hat{ω} ( t ) = \frac{\hat{ω} ( t )}{\sum \hat{ω} ( t ) + δ} \qquad ( 6 )$$

Here, δ is a minimal value for preventing ω from being all zero. After updating ω, in conjunction with equation (3), the model parameters θ are optimized again using the samples in the training dataset.

Step 7: FIG. 5 shows an example of applying the trained U-Net model to field data, and compares it with the traditional, widely used STA/LTA first-arrival picking algorithm. This intuitively demonstrates the effectiveness and superiority of the present disclosure in the first-arrival picking task, possessing the capability to perform accurate and rapid first-arrival picking under complex geological conditions and low signal-to-noise ratio environments.

Based on the same inventive concept, the present disclosure proposes a system for first-arrival picking of seismic data, including: an acquisition device configured to acquire seismic data; a dataset generation device configured to use an automatic first-arrival picking algorithm to perform preliminary picking of first-arrival times of seismic signals in the seismic data, and generate a meta-learning dataset, wherein the meta-learning dataset includes a training set and a validation set; a model generation device configured to design a corresponding deep neural network model based on characteristics of the meta-learning dataset; a training device configured to perform iterative training on the deep neural network model by using the meta-learning dataset based on an inner and outer double-loop training procedure of meta-learning; wherein each iterative training includes the following steps: sampling N mini-batch samples from the training set; assigning meta-network weights \hat{θ} to an independent sub-network; sampling M mini-batch samples from the validation set; using online gradient update, computing a sub-network loss, and backpropagating to optimize a weight matrix ω; using the N mini-batch training samples and a processed weight matrix ω* resulting from processing the optimized weight matrix ω, calculating a gradient by using a loss function, and backpropagating to optimize the meta-network weights \hat{θ}; and a first-arrival picking device configured to use the trained deep neural network model to perform first-arrival picking on to-be-detected seismic data.

Based on the same inventive concept, the present disclosure further proposes a computer device for first-arrival picking of seismic data, including: a memory, a processor, and a computer program stored in the memory, wherein the processor, when executing the computer program, implements the steps of the method for first-arrival picking of seismic data described above.

The above description is only a preferred specific implementation of the present disclosure, but the protection scope of the present disclosure is not limited thereto. Any equivalent substitution or change made by any person skilled in the art within the technical scope disclosed by the present disclosure based on the technical solutions and the inventive concept thereof shall be covered within the protection scope of the present disclosure.

What is claimed is:

1. A method for first-arrival picking of seismic data, comprising:
acquiring seismic data;
using an automatic first-arrival picking algorithm to perform preliminary picking of first-arrival times of seismic signals in the seismic data, and generating a meta-learning dataset, wherein the meta-learning dataset comprises a training set and a validation set; wherein the using the automatic first-arrival picking algorithm to perform preliminary picking of first-arrival times of seismic signals in the seismic data to generate the meta-learning dataset specifically comprises: classifying sampling points before and after the picked first-arrival time into two categories of pre-first-arrival and post-first-arrival, and respectively assigning different labels thereto; using a first-arrival picking result with errors from the automatic first-arrival picking algorithm as a noisy label; using a first-arrival time subjected to manual correction as a clean label; and generating the meta-learning dataset based on the noisy labels and the clean labels;
performing iterative training on a deep neural network model by using the meta-learning dataset based on an inner and outer double-loop training procedure of meta-learning;
inputting to-be-detected seismic data into the trained deep neural network model, and outputting a first-arrival picking result of the to-be-detected seismic data;
wherein in the step of performing the iterative training on the deep neural network model by using the meta-learning dataset based on the inner and outer double-loop training procedure of meta-learning, each iteration of the iterative training comprises the following steps:
sampling N mini-batch samples from the training set;
assigning meta-network weights \hat{θ} to an independent sub-network;
sampling M mini-batch samples from the validation set;
using online gradient update, computing a sub-network loss, and backpropagating to optimize a weight matrix ω;
using the N mini-batch training samples and a processed weight matrix ω* resulting from processing the optimized weight matrix ω, calculating a gradient by using a loss function, and backpropagating to optimize the meta-network weights \hat{θ}; wherein a loss function used is expressed as:
Loss=ωfᵢ(θ)
wherein ω is a weight matrix, fᵢ(θ) represents a loss function associated with a noisy label i, and θ represents trainable parameters of the deep neural network model;
wherein the using the N mini-batch training samples and the processed weight matrix ω* resulting from processing the optimized weight matrix ω, calculating a gradient by using the loss function, and backpropagating to optimize the meta-network weights \hat{θ} is specifically expressed as:
$$\{ \begin{matrix}θ * ( ω ) = arg min {\sum }_{i = 1}^{N} {ω f}_{i} ( θ ) \\ ω *= arg min {\sum }_{j = 1}^{M} {f}_{j} ( θ ( ω ) )\end{matrix}$$
wherein the symbol * denotes an optimal value of a parameter, and fᵢ represents a loss function associated with a clean label j.

2. The method for first-arrival picking of seismic data according to claim 1, wherein after acquiring the seismic data, the seismic data is subjected to filtering, and then the filtered seismic data is subjected to cropping, normalization, and first-arrival picking operations.

3. The method for first-arrival picking of seismic data according to claim 1, wherein input data of the deep neural network model is a seismic record, each seismic record comprises 64 seismic traces, each seismic trace comprises 512 sampling points, and an interval between the sampling points is 10 milliseconds; and an output of the deep neural network model is a 0-1 matrix.

4. The method for first-arrival picking of seismic data according to claim 1, wherein the deep neural network model is a U-Net model.

5. The method for first-arrival picking of seismic data according to claim 1, wherein the using online gradient update, computing a sub-network loss, and backpropagating to optimize the weight matrix ω comprises:
expressing an estimated value of the weight matrix ω as:
$$\hat{ω} ( t ) = - η \frac{\partial }{\partial ω} \frac{1}{m} {\sum }_{j = 1}^{m} {f}_{j} ( {θ}_{t + 1} ( ω ) {\vert}_{ω ← 0} )$$
wherein η is a learning rate of ω, t represents a current iteration number, and m is a number of samples in the M mini-batch samples;
performing normalization processing on the estimated value \hat{ω}(t), which is expressed as:
ω(t)=max(0,\hat{ω}(t))
$$\hat{ω} ( t ) = \frac{\hat{ω} ( t )}{\sum \hat{ω} ( t ) + δ}$$
wherein δ is a minimal value for preventing ω from being all zero, and the estimated value \hat{ω}(t) is a positive number.
